(19) United States
(12) Patent Application Publication
(10) Pub. No.: US 2017/0326482 A1
(43) Pub. Date: Nov. 16, 2017

(54) SYSTEMS AND APPARATUS FOR A FLUID FILTRATION DEVICE

(71) Applicant: Phil-Up, LLC, Phoenix, AZ (US)

(72) Inventors: Edward Prchal, Phoenix, AZ (US); Andrew Prchal, Phoenx, AZ (US)

(21) Appl. No.: 15/590,391

(22) Filed: May 9, 2017

Related U.S. Application Data
(60) Provisional application No. 62/334,916, filed on May 11, 2016.

(51) Int. Cl. B01D 35/153; B01D 35/30; B01D 35/00

(52) U.S. Cl. CPC B01D 35/153; B01D 35/00; B01D 35/306

(57) ABSTRACT

Systems and apparatus for a fluid filtration device may include a filter housing having openings disposed along a sidewall of the filter housing and a check valve extending outwardly from a first end of the filter housing. The fluid filtration device may include a riser coupled to a second end of the filter housing and a filter cap coupled to a second end of the riser. The filter cap may have an opening fluidly linked to the riser and the filter housing and be configured to selectively attach the fluid filtration device to a container for holding fluids such as a three to six gallon refillable water container.

### CROSS-REFERENCES TO RELATED APPLICATIONS

This application claims the benefit of U.S. Provisional Patent Application No. 62/334,916, filed May 11, 2017, and incorporates the disclosure by reference. To the extent that the present disclosure conflicts with any referenced application, however, the present disclosure is to be given priority.

### BACKGROUND OF INVENTION

Consumers utilize standardized refillable three to five-gallon water containers in a variety of locations such as their homes, offices, schools, and the like. Typically, five-gallon water containers are provided by a subscription based service provider, wherein the service provider exchanges or otherwise refills the five-gallon water container based on a monthly or yearly subscription fee. The water provided by these operations come pre-filtered, and the consumer generally does not need to further filter the water once the five-gallon water container has been delivered. Thus, the consumer is reliant on the water service provider to provide five-gallon water containers with filtered water. However, the consumer is limited in ways to filter tap water coming out of their faucets. Common filter devices such as the Brita® filter does not provide for the ability to filter a large container of water such as the standard three to five-gallon water container. Furthermore, the certain filter may only provide water filtration when water is actively entering the filter device which may not be sufficient to properly filter unwanted material out of the water.

### SUMMARY OF THE INVENTION

Systems and apparatus for a fluid filtration device may include a filter housing having openings disposed along a sidewall of the filter housing and a check valve extending outwardly from a first end of the filter housing. The fluid filtration device may include a riser coupled to a second end of the filter housing and a filter cap coupled to a second end of the riser. The filter cap may have an opening fluidly linked to the riser and the filter housing and be configured to selectively attach the fluid filtration device to a container for holding fluids such as a three to six gallon refillable water container.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1A representatively illustrates a perspective view of an exemplary embodiment of the filtration device;

FIG. 1B representatively illustrates a second perspective view of the filtration device;

FIG. 1C representatively illustrates an exploded view of the filtration device shown in FIGS. 1A and 1B;

FIG. 2A representatively illustrates a first perspective view of an alternative embodiment of the filtration device;

FIG. 2B representatively illustrates a second perspective view of the filtration device shown in FIG. 2A;

FIG. 3 representatively illustrates an exploded view of the filtration device shown in FIGS. 2A and 2B;

FIG. 4 representatively illustrates a cross-sectional view of the filtration device shown in FIGS. 1A and 1B;

FIG. 5A representatively illustrates a first perspective view of a filter housing;

FIG. 5B representatively illustrates a second perspective view of the filter housing;

FIG. 6A representatively illustrates a first perspective view of a check valve of an exemplary embodiment of the filtration device;

FIG. 6B representatively illustrates a second perspective view of the check valve of an exemplary embodiment of the filtration device;

FIG. 7A representatively illustrates a first perspective view of a riser of an exemplary embodiment of the filtration device;

FIG. 7B representatively illustrates a second perspective view of the riser of an exemplary embodiment of the filtration device;

FIG. 8A representatively illustrates a first perspective view of a filter cap of an exemplary embodiment of the filtration device;

FIG. 8B representatively illustrates a second perspective view of the filter cap of an exemplary embodiment of the filtration device;

FIG. 9 representatively illustrates a filter in accordance with an exemplary embodiment of the filtration device; and

FIG. 10 representatively illustrates the filtration device coupled to a water container in accordance with an exemplary embodiment of the filtration device.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various process steps, apparatus, systems, methods, etc. In addition, the present technology may be practiced in conjunction with any number of systems and methods for filtering fluids, and the system described is merely one exemplary application for the technology. Further, the present technology may employ any number of conventional techniques for filtering materials contained within a container.

The particular implementations shown and described are illustrative of the technology and its best mode and are not intended to otherwise limit the scope of the present technology in any way. For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Systems and apparatus for a fluid filtration device according to various aspects of the present technology may operate in conjunction with any suitable filtration media intended to remove contaminants from a fluid such as water. Various representative implementations of the present technology may be applied to any container configured to contain a fluid such as common refillable water containers used to provide drinking water from dispensers such as water coolers, crocks, and the like.

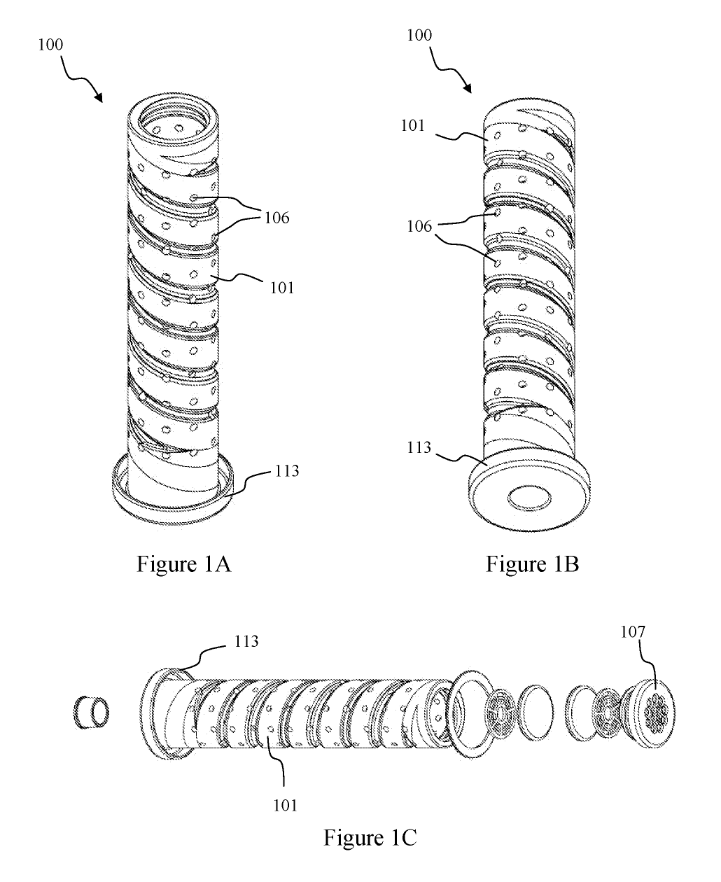

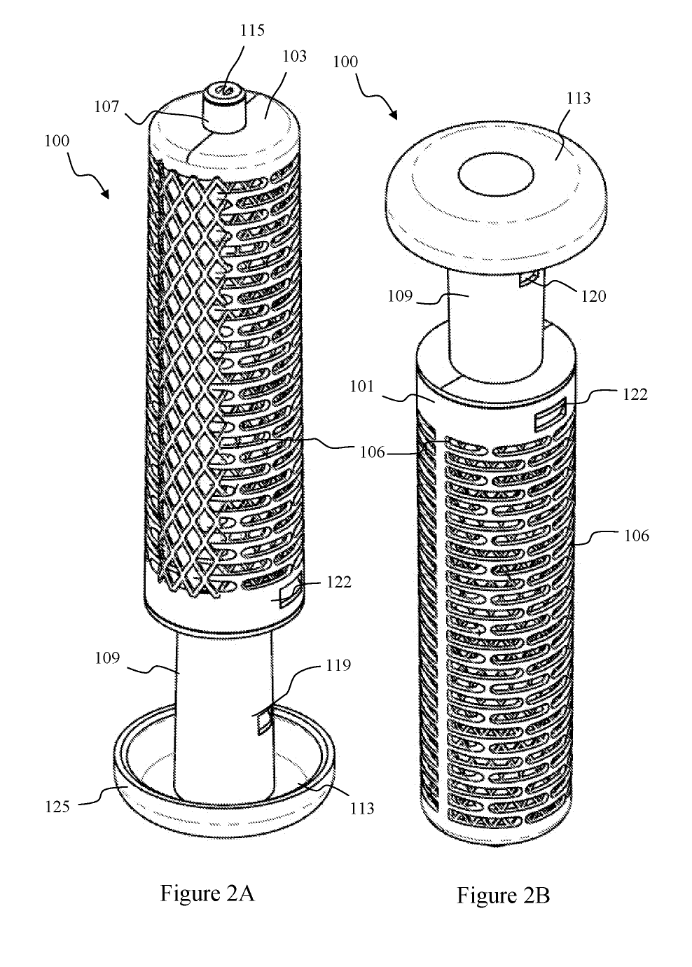

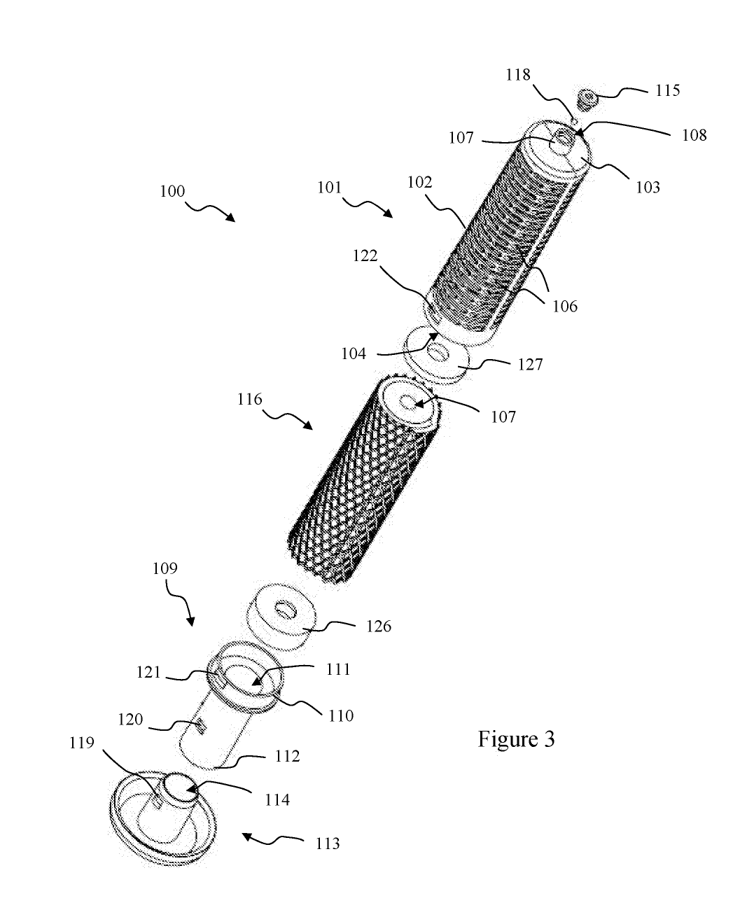

Referring to FIGS. 1A-C in one embodiment, the filtration device 100 may comprise a filter housing 101 having a check valve 107 disposed at a first end 103 of the filter housing 101 and a filter cap 113 disposed at a second end of the filter housing 101. The filter housing may be sized to be fit inside the refillable water container and secured in place by attaching the filter cap 113 to the refillable water container. Referring now to FIGS. 2A, 2B, and 3, in an alternative embodiment, the filtration device may further comprise a riser 109 disposed between the second end 104 of the filter housing 101 and the filter cap 113. The check valve 107 may be configured to selectively seal off a channel 108.

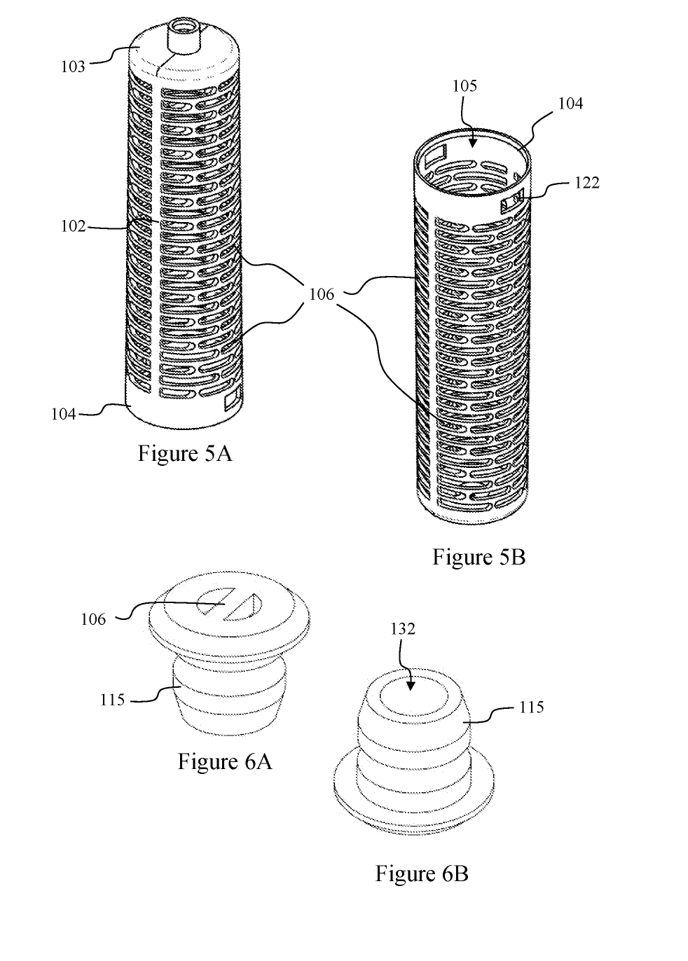

Now referring to FIGS. 1A, 3, 5A, 5B, and 10 the filter housing 101 may comprise a sidewall 102 extending between the first end 103 and the second end 104 forming an open interior receiving area 105. The second end 104 may open to allow a filter 116 to be inserted to the open interior receiving area 105 while the first end 103 is at least partially closed off to secure the filter 116 inside of the open interior receiving area 105. The sidewall 102 may comprise any suitable size or shape such as a substantially cylindrical or tubular shape having any suitable length or diameter. For example, in one embodiment, the sidewall may comprise a diameter of between one and two inches such that the sidewall may be inserted into an open end of a standard refillable three to five gallon water container 1000.

The sidewall 102 may comprise a plurality of openings 106 configured to allow fluid to flow from outside of the filter housing 101 into the open interior receiving area 105. The plurality of openings 106 may comprise any suitable shape, size, and/or form. For example, in one embodiment, the plurality of openings 106 may comprises a series of elliptically shaped holes arranged in an array extending between the first end 103 and the second end 104.

The filter housing 101 may comprise any suitable structure and may be formed as a single piece or a plurality of pieces coupled together to form the filter housing 101. The filter housing 101 may comprise any suitable material such as plastics, metals, wood, and/or the like.

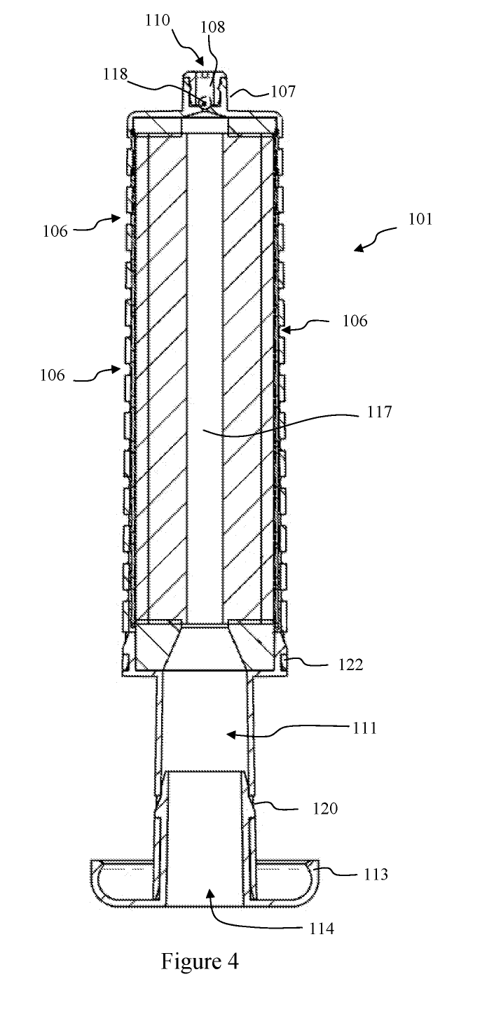

The check valve 107 helps maintain proper pressurization within the container 1000. The check valve 107 may comprise any suitable system or device for allowing air to enter the container 1000 as fluid is drawn from the container 1000. For example, and referring now to FIGS. 2A, 2B, 3, and 4, in one embodiment, the check valve 107 may comprise a protrusion extending outwardly from the first end 103 of the filter housing 101. The protrusion may comprise a channel 108 fluidly linked to the open interior receiving area 105. The check valve 107 may further comprise a ball bearing device 118 configured to selectively seal off the channel 108 from the open interior receiving area 105. The ball bearing device 118 may be configured move within the channel 108 to allow air entering the water filtration device 100 to exit out of the channel 108. The ball bearing device 118 may comprise any suitable device configured to block and/or otherwise prevent material from entering and/or exiting the channel 108. The ball bearing device 118 may comprise a material with sufficient density and/or mass such that the default position of the ball bearing device 118 is one that blocks the channel 108. Alternatively, the ball bearing device 118 may be biased against a seat 123 under the force of a spring (not shown).

In one embodiment, the ball bearing device 118 may be shifted between a first position and a second position under the force created by air collecting in the receiving area 105 and/or channel 108. In the first position, the ball bearing device 118 may be positioned over the seat 123 such that the channel 108 is blocked by the ball bearing device 118.

For example, the filtration device 100 may be attached to a five-gallon water container 1000, and the water container 1000 may be placed on a water dispensing unit (not shown). When a user actives the water dispensing unit, air may travel upward through an opening 114 of the filter cap 113, flow through the riser 109, and into the open interior receiving area 105. As air pressure builds, the ball bearing device 118 may be unseated from a first position sealing off the channel 108 from the open interior receiving area 105. After the ball bearing device 118 is unseated air may flow through the channel 108 and into the container 1000 equalizing the pressure inside of the container 1000 with that of the surrounding environment. As the pressure equalizes, the ball bearing device 118 may be forced back against its seat 123 to seal off the channel 108.

Now referring to FIGS. 2B, 3, 4, 6A, and 6B, in one embodiment, the check valve 107 may comprise an end cap 115 comprising an inner channel 132. The inner channel 132 may be disposed within the channel 108 to help control the movement of the ball bearing device 118. The end cap 115 may further comprise a cross bar 133 configured to divide the opening of the inner channel 132 into two halves and act as a ceiling for the ball bearing device 118 preventing the ball bearing device 118 from escaping and/or otherwise exiting the filtration device 100. For example, as discussed above, when air travels from the filter cap 113 towards the check valve 115, the upward force of the air may cause the ball bearing deice 118 to shift from a first position to a second position. When the ball bearing deice 118 is shifted into the second position, the air may travel around the ball bearing device 118 and escape out of the check valve 115 via the inner channel 132.

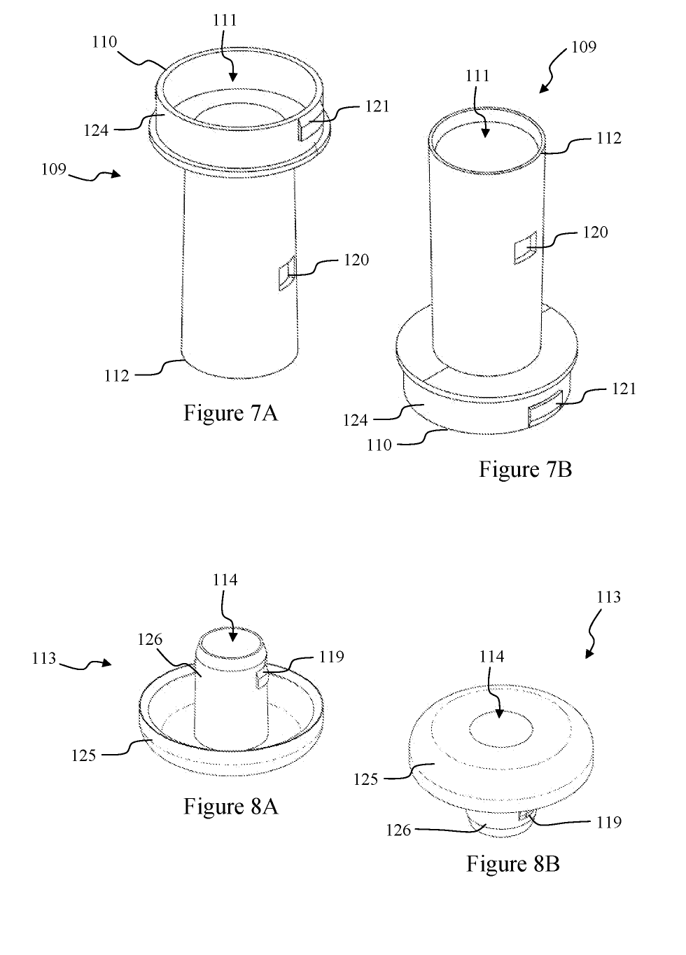

Referring again to FIGS. 2A, 2B, 3, 4, and 7A the riser 109 separates the filter housing 101 from the filter cap 113 and provides a fluid conduit between the opening 114 of the filter cap 113 and the open interior receiving area 105. The riser 109 may comprise any suitable device configured to couple a filter cap 113 to the filter housing 101. In one embodiment, the riser 109 may comprise a first end 110 configured to be coupled to the second end 104 of the filter housing 101 to at least partially close off the open internal receiving area 105 and secure the filter 116 inside of the open interior receiving area 105.

The first end 110 of the riser 109 may be coupled to the filter housing 101 by any suitable method or device such as a rotatable fitting, locking tabs, fasteners, adhesive, or the like. The first end 110 of the riser 109 may also be configured to be selectively attached or connected to the filter housing 101 such that the riser 109 may be removed to allow for replacement of the filter 116. Alternatively, the first end 110 may be configured to be permanently connected to the filter housing 101 to prevent replacement and/or removal of the filter 116. For example, the first end 110 of the riser 109 may comprise a riser locking mechanism 121 configured to mate to a corresponding riser locking mechanism 122 on the second end 104 of the filter housing 101. The riser locking mechanism 121 may comprise a protrusion, and the corresponding riser locking mechanism 122 may comprise an open receiving area configured to receive the protrusion of the riser locking mechanism 121. The first end 110 of the riser 109 may further comprise a raised lip 124. The raised lip 124 may be configured with a riser locking mechanism 121. The diameter and/or size of the raised lip 124 may be configured to match the diameter and/or size of the filter housing 101 such that the raised lip 124 is configured to fit within an interior perimeter of the filter housing 101.

The riser locking mechanism 121 and the corresponding riser locking mechanism 122 may be configured to form a water-tight seal when coupled together. It is understood to those skilled in the art that the riser locking mechanism 121 and the corresponding riser locking mechanism 122 may be alternatively disposed. For example, the protrusion may be disposed on the filter housing 101 and the open receiving area may be disposed on the riser 109, or vice versa.

The riser 109 may also comprise an inner conduit 111 extending between the first end 110 and second end 112 of the riser 109. The inner conduit 111 may be fluidly linked to the open internal receiving area 105 of the filter housing 101. For example, a fluid may be allowed to flow between the open internal receiving area 105 and the inner conduit 111 when the riser 109 is coupled to the filter housing 101.

The inner conduit 111 may comprise a substantially cylindrical shape having a diameter that is generally less than that of the filter housing 101. The diameter of the inner conduit 111 may vary depending on the particular requirements/specifications of the filtration device 100. For example, depending on the material being filtered by the filtration device 100, the diameter of the inner conduit 111 may be larger or smaller. The diameter of the inner conduit 111 may also be selected according to a desired flow rate of fluid through the filtration device 100.

Now referring to FIGS. 2A, 2B, 3, 4, 8A, 8B and 10, the filter cap 113 is used to attach the filtration device 100 to an open end of a water container 1000. The filter cap 113 may comprise any suitable device configured to couple the filtration device 100 to the water container 1000. For example, the filter cap 113 may be configured to couple the filtration device 100 to the lip of a standardized five-gallon water container 1000 such that the filtration device 100 is disposed within the five-gallon water container 1000 during use.

In one embodiment, the filter cap 113 may comprise an opening 114 extending from a first side of the filter cap 113 to a second side of the filter cap 113. The opening 114 provides a fluid conduit allowing water to flow from the inner conduit 111 and exit the filtration device 100 through the filter cap 113. For example the opening 114 may be configured to be placed proximate a fluid output port or a tank of a water dispensing unit (not shown). In this configuration, a fluid may travel through the open interior receiving area 105 of the filter housing 101, through the filter 116, into the inner conduit 111 of the riser 109, and into the opening 114 of the filter cap 113 before exiting into the water dispensing unit.

The filter cap 113 may comprise any suitable size, shape, or dimension according to a particular application, water container, or water dispensing unit. In one embodiment, the filter cap 113 may comprise a substantially circular shape generally corresponding to the size of the lip/spout of the standardized five-gallon water container 1000. An underside of the filter cap 113 may comprise a folded lip 125 extending outwardly from a top surface of the filter cap 113 towards the filter housing 101 that is configured to attach to or otherwise couple the filter cap 113 to the lip/spout of the five-gallon water container 1000. The height of the folded lip 125 may vary depending on the particular water container 1000.

The filter cap 113 may further comprise a substantially cylindrical body 126 extending outwardly from the underside of the filter cap 113 to create the fluid conduit through the filter cap 113. The cylindrical body 126 may be suitably configured to connect to the second end of the riser 109 by any suitable method or device. For example, the cylindrical body 126 may comprise a filter cap locking mechanism 119 configured to mate to a corresponding filter cap locking mechanism 120 on the second end 112 of the riser 109. The filter cap locking mechanism 119 and corresponding filter cap locking mechanism 120 may comprise any suitable system configured to couple the filter cap 113 to the riser 109. For example, the filter cap locking mechanism 119 and corresponding filter cap locking mechanism 120 may comprise a similar protrusion and open receiving area similar to the system described above as utilized by the riser 109 and filter housing 101.

The filter cap locking mechanism 119 may be detachably coupled to the corresponding filter cap locking mechanism 120. For example, the protrusion of the filter cap locking mechanism 119 may be popped out and/or otherwise removed from the open receiving area of the corresponding filter cap locking mechanism 120. In other embodiments, the filter cap locking mechanism 119 and corresponding filter cap locking mechanism 120 may be configured to form a permanent (i.e., non-detachable) attachment. The filter cap locking mechanism 119 and corresponding filter cap locking mechanism 120 may be configured to form a water-tight seal when coupled together. Similar to the riser 109, it is understood by those skilled in the art that the filter cap locking mechanism 119 and the corresponding filter cap locking mechanism 120 may be alternatively disposed. For example, the protrusion may be disposed on the corresponding filter cap locking mechanism 120, or vice versa.

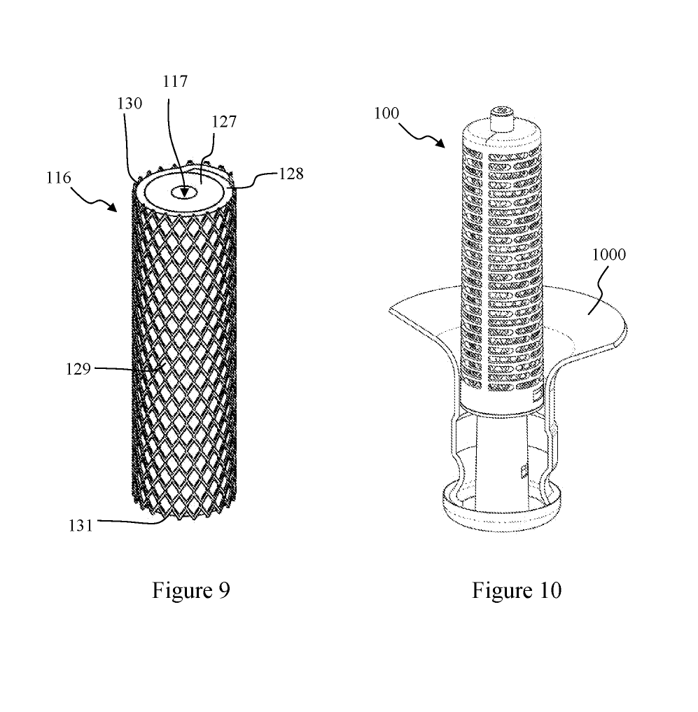

Referring now to FIGS. 3, 9, and 10, in one embodiment, the filter 116 may be positioned within the open internal receiving area 105 along with a first gasket 126 and a second gasket 127. The first gasket 126 may be disposed between the first end 110 of the riser 109 and a first end 130 of the filter 116. The second gasket 127 may be disposed between the second end 131 of the filter 116 and the first end 103 of the filter housing 101. Each of the first gasket 126 and the second gasket 127 may comprise an opening configured to be fluidly linked to an open inner portion 117 of the filter device 100 to allow for the flow of filtered water to pass through the filter housing 101. The first gasket 126 and second gasket 127 may comprise any suitable material configured to provide a water-tight seal.

The filter 116 may comprise any suitable device for filtering a fluid such as water. For example, the filter 116 may comprise a charcoal filter, a series of filtration pads, an exchange media, or any combination thereof. For example, in one embodiment, the filter 116 may comprise an outer mesh net 129 configured to wrap around and contain a first filter layer 128. A first filter layer 128 may be configured to wrap a second filter layer 127. The first filter layer 128 and second filter layer 127 may comprise any suitable system or device configured to provide filtration capabilities. For example, in one embodiment, the first filter layer 128 may comprise a filter pad configured to filter out various materials from the material to be filtered. The second filter layer 127 may comprise a charcoal filter configured to filter out various materials from the material to be filtered. The filter layers may be suitably configured to filter out any desired level of contaminants between about 0.5 to 50 micrometers.

In one embodiment, when the filtration device 100 is attached to a five-gallon water container 1000, the water within the water container 1000 may come into contact with the filter 116. The water may enter the open internal receiving area 105 via the plurality of openings 106 disposed on the sidewall 102 of the filter housing 101. The water entering the receiving area 105 may first come into contact with the mesh net 129 of the filtration device 116 before reaching the first filter layer 128 where it is filtered at a first level prior to reaching the second filter layer 127 where the water is filtered at a second level. In general, the second level of filtration may comprise a finer grade that the first level. For example, the first level of filtration may comprise a 10 micrometer carbon filter pad and the second level of filtration may comprise a 1 micrometer carbon filter pad. However, the order and level of filtration may be altered as necessary to achieve a desired level of filtration.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A filtration device for a fluid, comprising:
a filter housing comprising:
a sidewall extending between a first and a second end forming an open interior receiving area;
a plurality of openings disposed along the sidewall and configured to allow the fluid to flow into the open interior receiving area; and
a check valve disposed at the first end of the filter housing and configured to seal off the open interior receiving area, wherein the check valve comprises:
a channel fluidly linked to the open internal receiving area; and
an end cap configured to cover the channel; and
a filter cap configured to be coupled to a second end of the riser, wherein the filter cap comprises an opening fluidly linked to the inner conduit.

2. The filtration device of claim 1, further comprising a riser disposed between the filter housing and the filter cap, wherein the riser comprises:
a first end configured to be coupled to the second end of the filter housing to at least partially close off the open internal receiving area; and
an inner conduit extending between the first end and a second end, wherein the inner conduit is fluidly linked to the open internal receiving area.

3. The filtration device of claim 1, further comprising a water filter device disposed within the receiving area, wherein the water filter device comprises an open inner portion for receiving filtered fluid.

4. The filtration device of claim 1, wherein the check valve is configured to allow air entering the filtration device to exit out of the channel.

5. The filtration device of claim 1, wherein the check valve comprises:
a ball bearing device; and
a seat disposed within the channel and configured to receive at least a portion of the ball bearing device to seal off the channel from the open internal receiving area.

6. The filtration device of claim 5, wherein the ball bearing device is shifted from a first position to a second position under a force created by air collecting in the open internal receiving area.

7. The filtration device of claim 5, wherein the end cap comprises a cross bar dividing an opening of the check valve into two halves.

8. The filtration device of claim 7, wherein the cross bar retains the ball bearing device within the channel.

9. The filtration device of claim 1, wherein the filter cap comprises a locking mechanism configured to mate to a corresponding second locking mechanism on the second end of the riser.

10. The filtration device of claim 1, wherein the first end of the riser comprises a locking mechanism configured to mate to a corresponding second locking mechanism on the second end of the filter housing.

11. A water filtration device for a standardized refillable water container used with a water dispensing unit, comprising:
a filter housing, comprising:
a sidewall extending between a first and a second end forming an open interior receiving area;
a plurality of openings disposed along the sidewall and configured to allow the fluid to flow into the open interior receiving area; and
a check valve disposed at the first end of the filter housing and configured to seal off the open interior receiving area, wherein the check valve comprises:
a channel fluidly linked to the open internal receiving area; and
an end cap configured to cover the channel;
a riser comprising:
a first end coupled to the second end of the filter housing to at least partially close off the open internal receiving area; and
an inner conduit extending between the first end and a second end, wherein the inner conduit is fluidly linked to the open internal receiving area;
a filter cap coupled to a second end of the riser, wherein:
the filter cap comprises an opening fluidly linked to the inner conduit; and
the filter cap is configured to fit around a lip of the refillable water container; and
a water filter disposed within the receiving area.

12. The water filtration device of claim 11, wherein the water filter comprises an open inner portion for receiving filtered water.

13. The water filtration device of claim 12, wherein the water filter further comprises:
a mesh net configured to wrap around and contain a first filter layer; and
a second filter layer disposed between the first filter layer and the open inner portion.

14. The water filtration device of claim 11, wherein the check valve is configured to allow air entering the water filtration device to exit out of the channel.

15. The water filtration device of claim 11, wherein the check valve comprises:
a ball bearing device; and
a seat disposed within the channel and configured to receive at least a portion of the ball bearing device to seal off the channel from the open internal receiving area.

16. The water filtration device of claim 15, wherein the ball bearing device is shifted from a first position to a second position under a force created by air collecting in the open internal receiving area.

17. The filtration device of claim 15, wherein the end cap comprises a cross bar dividing an opening of the check valve into two halves.

18. The filtration device of claim 17, wherein the end cap comprises a cross bar dividing an opening of the check valve into two halves.

19. The water filtration device of claim 11, wherein the filter cap comprises a locking mechanism configured to mate to a corresponding second locking mechanism on the second end of the riser.

20. The water filtration device of claim 11, wherein the first end of the riser comprises a locking mechanism configured to mate to a corresponding second locking mechanism on the second end of the filter housing.
